(19) United States
(12) Patent Application Publication
(10) Pub. No.: US 2018/0121938 A1
(43) Pub. Date: May 3, 2018

(54) System and method for digital audience estimation

(71) Applicant: Verto Analytics Oy, Espoo (FI)

(72) Inventors: Hannu VERKASALO, Engelberg (CH); Chris MODZELEWSKI, Boonton, NJ (US)

(73) Assignee: Verto Analytics Oy, Espoo (FI)

(21) Appl. No.: 15/853,352

(22) Filed: Dec. 22, 2017

Related U.S. Application Data
(63) Continuation of application No. PCT/FI2015/050742, filed on Jun. 26, 2015.

(51) Int. Cl. G06Q 30/02; G06F 17/30; G06N 5/04

(52) U.S. Cl. CPC G06Q 30/0201; G06N 5/04; G06F 17/30867; G06Q 30/0242

(57) ABSTRACT

A method for estimating the digital audience (102a, 102b, 102c) reached by a digital network (110) on at least one digital platform (104a, 104b, 104c) to be performed by computer equipment (114, 114B), comprising monitoring transactions (105a, 105b, 105c, 106) on said platform in the digital network for a predefined period, wherein the predefined period comprises at least a preliminary period, target period, and post-period, which are temporally sequential, capturing device-related identifiers associated with the observed transactions, wherein the device-related identifier preferably anonymously identifies a device or device user or related application profile, optionally a browser profile, determining, for each captured device-related identifier, whether it was observed at least once during both said preliminary period and said post-period, to extract persistent device-related identifiers from the captured device-related identifiers, and calculating statistics preferably containing aggregate statistics having regard to the persistent device-related identifiers and related transactions, during the target period. A system and computer program for executing the method are presented.

### PRIORITY

This application is continuation application of international patent application number PCT/FI2015/050742 filed on Jun. 26, 2015, the contents of which is incorporated herein by reference in its entirety.

### FIELD OF INVENTION

The invention relates to an electronic system and related method for estimating the audience of digital media. Particularly, however not exclusively, the present invention pertains to estimating the audience receiving content over digital networks using electronic terminal devices such as desktop or mobile computers.

### BACKGROUND

Audience measurement is traditionally understood as measuring the number of watchers or listeners a certain television or radio channel, or a particular program, has. Also the circulation of printed media such as newspapers or magazines has been measured for decades already.

Modern digital media such as the Internet and related web pages or websites have recently become the most rapidly growing media branch with their own special characteristics such as so-called social media, while simultaneously also introducing a new form of mass media in addition to print media and traditional broadcast media, and also partially replacing those, whereupon estimating the related audience has similarly risen in importance.

A number of solutions have popped up in the context of digital media audience measurement. For example, ‘hits’ (visits) on web pages have been monitored over a predefined period, user interactions tracked having regard to social media sites and video analytics performed on the viewers of online media.

However, despite the many advantages the contemporary audience measurement solutions admittedly have over more traditional written or telephone surveys, for example, there still remains room for improvement.

Modern media consumption occurs across multiple platforms, where each platform used has its own characteristics affecting related measurements. Examples of platforms which may—alone or in combination—be used to consume modern media include computers (e.g. desktops and laptops) consuming web sites or applications, mobile devices (smartphones, tablets, phablets, wristop devices, etc.) consuming apps, or mobile devices (smartphones, tablets, phablets, wristop devices, etc.) consuming web sites.

For example, the usage of web sites on desktop or laptop computers may be measured via JavaScript™ tags embedded into the web pages of third-party web publishers and then executed via web browsers deployed on traditional desktop, laptop, or notebook computers. Using similar principles, mobile apps may be measured via an SDK (software development kit) integrated into mobile apps developed by third-party developers, while the usage of web sites on mobile devices may be measured again via JavaScript tags embedded into the web pages of third-party web publishers and subsequently executed via mobile devices (e.g. smartphones, tablets, etc.).

Regardless of the underlying technical method, counting, estimating, or otherwise measuring the number of unique users consuming specific web sites or apps either on specific or across multiple platforms is generally challenging in digital media and the techniques and their reliability varies across platforms.

Even within a platform, the reliability of unique user estimation may be different across different mobile devices, which have different levels of support for key technical tools used in the user identification process.

Further, a unique user potentially properly detected on one platform may be double-counted as another user on another platform. We talk about user duplication in these cases.

Yet, a given individual may be correctly observed and documented as a unique user at one point in time, but the same individual may not be recognized upon subsequent use of the network and is thus counted as another user.

### SUMMARY

It is the objective of the invention to at least alleviate one or more drawbacks related to the prior art.

The objective is achieved by the various embodiments of a method and a system as defined in the appended claims.

In one aspect, a method for estimating the digital audience reached by a digital network on a digital platform to be performed by computer equipment, comprises
monitoring transactions on said platform in the digital network for a predefined period, wherein the predefined period comprises at least a preliminary period, target period, and post-period, which are temporally sequential,
capturing device-related identifiers associated with the observed transactions, wherein the device-related identifier preferably anonymously identifies a device or device user or related application profile, such as browser profile,
determining, for each captured device-related identifier, whether it was observed at least once during both said preliminary period and said post-period, to extract persistent device-related identifiers from the captured device-related identifiers, and
calculating statistics preferably containing aggregate statistics having regard to the persistent device-related identifiers and related transactions, during the target period.

The above target period may refer to a time period of one month, for instance. Within the target period, other time period, or ‘sub-periods’, may be defined for analysis with finer temporal resolution, e.g. on a weekly or daily level. The (sub-) periods of the predetermined period may mutually be of the same or different duration.

In an embodiment, the calculated statistics may include at least one element selected from the group consisting of: persistent transactions during a time period obtained through calculating the total number of transactions associated with persistent device-related identifiers captured during the time period, transactions per persistent device during a time period obtained through dividing the total number of transactions associated with persistent device-related identifiers during the time period by the number of persistent device-related identifiers observed during the time period, total number of transactions delivered by the network during a time period, and net number of devices reached during a time period obtained through dividing the total number of transactions delivered during the time period by the corresponding persistent transactions per persistent device during the time period.

The calculation of statistics may thus involve keeping track of (counting, for example) the incidences of different device-related identifiers at least during the target period.

In an embodiment, the scope in terms of digital audience measurement may be limited to e.g. certain device types or other special characteristics. To calculate the audience for a particular characteristic, optionally having regard to a certain user-agent string or operating system, the method shall be applied to those transactions only delivered to devices with that particular characteristic. Accordingly, the total audience may be then calculated by taking the sum of the audience for each non-overlapping device characteristic.

In an embodiment, to calculate the audience among devices that do not support persistent identifiers, the number of transactions delivered to that audience may be divided by the corresponding transactions per persistent device value calculated across all device types. This assumes that—on average—a device that does not support such identifiers will generate the same number of transactions on a given time period as the devices that do.

In an embodiment, to deduplicate the audience and determine a net audience estimate across the overall digital network comprising a plurality of disparate platforms, optionally including standard (desktop/laptop) web, mobile web and/or mobile apps, device fingerprints may be captured, i.e. collected, calculated, and/or generated on multiple platforms, preferably produced using a functionally mutually identical or at least similar fingerprinting algorithm, so that it becomes feasible to match fingerprints between the platforms.

Matching may be performed utilizing a predefined matching algorithm or matching logic looking for similarities between the fingerprints. The fingerprints on multiple platforms considered to match each other (i.e. sufficiently similar if not substantially identical fingerprints), may be then considered to refer to same device or user from the standpoint of audience estimation. The associated counts may be combined for at least some of the established statistics as being understood by a person skilled in the art.

In an embodiment, the method comprises performing frequency capping or targeting having regard to data, optionally marketing, advertising, and/or promotional data, directed to a terminal device in connection with a transaction, for example. This is preferably executed based on the device-related identifiers captured and stored. By utilizing the identifiers to calculate the audience, the digital network can indeed determine the frequency with which e.g. a particular creative (or a particular campaign) has been delivered to each identifier (device). Up to date count of the creative/campaign deliveries may be thus maintained. Accordingly, the digital network is enabled to control the frequency with which that content such as creative or campaign is delivered to that particular device, which in turn would increase the value of that campaign to the media buyer.

In case fingerprinting has been implemented in multiple platforms to enable audience deduplication through matching the fingerprints or similar mutually comparable device-related identification data between the platforms, frequency capping/targeting may be performed across the platforms.

In an embodiment, a plurality of audience estimates may be deduplicated utilizing a panel-based media measurement data, which may be provided by a third party/external system. Utilizing this data, the number of users who used one platform encompassed by the digital network may be determined as well those users' incidence of usage of elements of a second platform encompassed by the digital network. This provides a ratio for combined reach which can then be applied to the (more accurate) platform-specific net audience number to produce deduplicated figures such as net audience estimate across both or generally multiple delivery platforms.

In one other aspect, a system for estimating the digital audience reached by a digital network on a digital platform, comprises

observation module configured to monitor transactions on said platform in the digital network for a predefined period, wherein the predefined period comprises at least a preliminary period, target period, and post-period, which are temporally sequential,
identification module configured to capture device-related identifiers associated with the observed transactions, wherein the device-related identifier preferably anonymously identifies a device or device user or related application profile such as browser profile,
persistence detection module configured to determine, for each captured device-related identifier, whether it was observed at least once during both said preliminary period and said post-period, to extract device-related identifiers that are considered temporally persistent from the captured device-related identifiers, and
analysis module configured to calculate statistics preferably containing aggregate statistics having regard to the persistent device-related identifiers and related transactions, during the target period.

In preferred embodiments, the system comprises or consists of at least one computer device, such as a server.

The previously presented considerations concerning the various embodiments of the method may be flexibly applied to the embodiments of the system mutatis mutandis as being appreciated by a skilled person.

The utility of the present invention is a result of many contributing factors depending on each particular embodiment. The suggested solution can be harnessed to estimate audience for given platforms both automatically and accurately. Its temporal resolution may be configured as desired to cover different time spans even simultaneously in the light of the associated analysis with e.g. daily, weekly, and monthly perspectives. Also spatial resolution may be configured (country level, state level, city, etc.) and related obtained data such as captured identifiers and established statistics analyzed independently. Even further, a number of other target factors such as occurrences of certain user-agents may be analyzed in the monitored transactions.

The solution provides for reliable estimation of audience (users/devices) on each platform and also across devices and even across platforms. Fingerprinting and e.g. panel data may be applied for audience deduplication among the platforms. By verifying the persistence of user identification over time, more accurate estimates of the total audience and e.g. transactions repeatedly involving same users can be obtained. Audience deduplication may be achieved also across the platforms, i.e. situations in which unique user identified (or estimated) on one platform is accidentally double-counted as a separate user on another platform are minimized.

In terms of privacy, the suggested procedure may be implemented as completely anonymous and omit personally-identifiable information. So, even if e.g. a user is identified in the context of the present invention, which may refer to distinguishing and recognizing a certain user account or profile from another, he/she will remain anonymous. The solution is generally in compliance with international privacy laws and does not rely on (though may still utilize) third-party cookies, for example. The implementations may be carried out so as to adhere to different industry standards such as the ones set by ICC (International Chamber of Commerce)/ESOMAR (European Society for Opinion and Market Research), IAB (Interactive Advertising Bureau), MMA (Mobile Marketing Association), and ARF Advertising Research Foundation).

As being already alluded hereinbefore, the term “transaction” refers herein to countable instance of content delivery delivered across a given platform using digital network. For example, transactions for which accurate counts can be computed may include (web) page requests, ad requests, page views, application views, and impressions (fetching ad from a source in a countable manner).

A digital content delivery framework or platform (e.g. content over the web displayed in a web browser on a desktop/laptop computer, content over the web displayed in a web browser on a smartphone/tablet, a mobile application activated on a mobile device, etc.) may have one or more methods of uniquely and anonymously identifying a given device or browser profile. Yet, different user accounts or user profiles may be considered as device-related identifiers (they can be utilized, accessed, controlled, etc. via different (terminal) devices, after all). Examples of anonymous identification methods may include cookies, registrations, Apple IDFAs™, or Google Advertising IDs™. For the purposes of this document, such platform-specific, device-related identifiers shall be referred herein to as “Platform-dependent Identifiers” or PDIs.

Any digital device can be described in terms of technical characteristics (e.g. screen resolution, color depth, installed plugins, hard disk size, operating system, user-agent, IP address, etc.). Given a sufficiently broad set of device characteristics, such a combination of specific device characteristics may constitute a “digital fingerprint” that is unique or near-unique for a given device or browser profile depending on implementation. For the purposes of this document, a combination of specific device characteristics (possibly aggregated/compressed into a token) shall be referred to as a “device fingerprint” or DF, which can be considered as one form of a device-related identifier.

For the purposes of this document, the output of a method for uniquely and anonymously identifying a given device, browser, or user profile that is considered persistent over a defined time period, i.e. a persistent device-related identifier, shall be hereinafter called a “Persistent Unique Identifier” (PUI). A PUI may either be constituted by or otherwise contain one or more PDIs or DFs.

The expression “a number of” may herein refer to any positive integer starting from one (1).

The expression “a plurality of” may refer to any positive integer starting from two (2), respectively.

Different embodiments of the present invention are disclosed in the attached dependent claims.

### BRIEF REVIEW OF THE DRAWINGS

Few embodiments of the present invention are next described in more detail hereinafter with reference to figures, in which

FIG. 1 illustrates an embodiment of a system in accordance with the present invention and related potential use scenario.

FIG. 2 is a block diagram representing the internals of an embodiment of a system comprising at least one device for implementing the present invention.

FIG. 3 is a flow diagram of an embodiment of a method in accordance with the present invention.

### DETAILED DESCRIPTION

In the context of the present disclosure, a digital network is capable of (technically) counting the number of transactions delivered to or generally involving a PUI. This assumption is generally met by most, if not all, contemporary digital networks one could basically think of. Likewise, the digital network is considered to be technically capable of counting the total number of transactions delivered to devices which do not have (or do not accept, or do not make available) a PUI.

Having regard to problems around PDI tracking, there arise a number of noteworthy issues some of which are briefly reviewed below.

First of all, the PDIs are often not stable over time. Modern PDIs are developed in such a way that they can even be reset on-demand by the device owner.

Secondly, the device owners can usually opt-out of PDIs for particular contexts. Some portion of the device owners may have disabled the acceptance/generation of or access to PDIs within or by particular applications (e.g. mobile apps, web browsers, etc.).

Further, the device owners may opt-out of PDIs for the entire device. Some portion of device owners will have thus disabled PDIs for their entire device, regardless of context.

Yet, in terms of privacy concerns, digital networks may strategically desire to minimize the amount of time that they store PDIs in favor of user privacy.

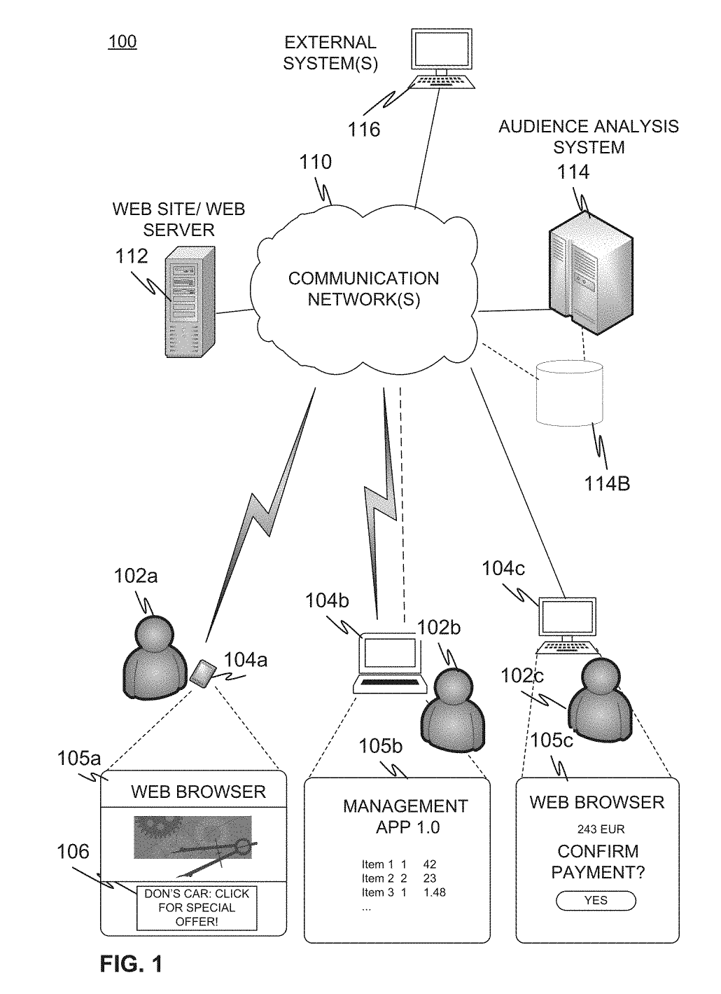

FIG. 1 shows, at 100, one merely exemplary use scenario involving an embodiment of a system 114 for audience estimation in a digital communication network 110. The network 110 may in practice include a plurality of networks or component networks that may have established on mutually similar or different platforms. For example, web sites consumed via desktop/laptop/notebook computers, web sites consumed via mobile devices, or apps (applications) consumed via mobile devices may be considered as such platforms. The associated transactions and related data transfer may be at least partially conducted over the Internet.

The system 114 may be implemented by one or more electronic devices such as servers and potential supplementary gear such as a number of routers, switches, gateways, and/or other network equipment. In a minimum case, a single device such as a server is capable of executing the method and may thus constitute the system.

The component devices of the system 114, in case there is a plurality, may be functionally connected via appropriate communication connections directly or via a number of intermediate entities. In some embodiments, multiple if not all devices of the system 114 may reside in a cloud computing environment. They may be at least partially dynamically allocable for the purposes of the system 114. Element 114B illustrates a database or other data repository for storing the identifier data and related analysis data (e.g. audience estimates). In real-life implementations, such repository 1146 may contain multiple physically distributed portions.

A plurality of terminal devices such as mobile 104a (cell phone, phablet, tablet, etc.), laptop 104b and desktop 104c terminals of users 102a, 102b, 102c, respectively, are involved in various aforementioned transactions that may be monitored by the system 114 either directly or via different functionally connected network elements such as web servers 112 dealing with the transactions. The transactions may include web page requests and related views 105a, ad requests 106, application views 105b, application downloads, payments 105c, etc.

A user 102a, 104b, 104c may have multiple devices in his/her possession. Similarly, a single device such as mobile device 104a may be capable of participating in transactions on multiple platforms, considering e.g. mobile web and native client applications (which may still transfer data over the network 110 and enable detection of related transactions).

The system 114 may be configured to monitor transactions, which may refer to pulling, requesting and receiving, relaying or otherwise getting access to data from external sources such as the server 112 or other external system(s) 116, which may include third party systems. The external system(s) 116 may be utilized to control the system 114 and related analysis tasks and/or to receive deliverables (gathered data, analysis results) provided by the system 114. The related UI may incorporate a web browser based UI supplied by a web server of the system 114 and/or other, potentially proprietary, data interfaces, for instance.

As mentioned hereinbefore, the present invention is preferably implemented in a manner that preserves the users' 102a, 104b, 104c privacy, i.e. the executing identification tasks are anonymous having regard to the actual identity of the users 102a, 104b, 104c.

The system 114 captures device-related identifiers associated with the transactions. In practical implementations, the system 114 may, for example, be provided with access to transaction data as mentioned hereinbefore, wherefrom device-related identifiers may be detected or derived, the latter action referencing in particular to different fingerprinting techniques applicable and resulting fingerprints, which may contain a collection of detected characterizing technical features or elements that together enable identifying the device. Fingerprints obtained from a transaction under analysis may be compared with (matched against) already existing ones to find matches and update (increase by one per occurrence, for example) the count of the matching fingerprint, or generally a device-related identifier.

For example, a browser fingerprinting algorithm may be applied. The fingerprint may include an indication of or describe at least one element selected from the group consisting of: user agent such as web browser (may be transmitted by/detected from HTTP (Hypertext Transfer Protocol) data and contain an indication of e.g. browser micro-version, OS version, language, toolbars and/or other device identification data), HTTP ACCEPT header (may be transmitted by HTTP), status of cookies (e.g. enabled/disabled) (inferable from HTTP), screen resolution, time zone, browser plug-ins, plug-in version, plug-in MIME type (plug-in features may be detected using e.g. a desired plug-in detector software), system fonts (Flash applet or Java applet), geolocation, IP (Internet Protocol) address, super cookie test and partial super cookie test.

Having regard to many of the above elements, JavaScript AJAX™ posts could be applied as sources of such data. Hundreds of device characteristics potentially suitable for use in digital (device) fingerprints can be generally captured using client-side JavaScript™. Alternatively or additionally e.g. Adobe Flash™ could be applied.

Capturing as such may thus involve more thorough analysis or relatively straightforward detecting and storing of device-related identifiers in connection with a transaction and the associated data.

In accordance with one basic principle of various embodiments of the present invention the occurrences of identifiers are monitored over a predefined time period, which may include a preliminary period, a target period, and a post-period.

For instance, a set of device-related identifiers which were observed at least once during a preliminary period such as one month and also at least once during a later period, i.e. a so-called post-period or ‘persistency delay’, such as one month as well, by definition had to exist (has not been reset) also during a target period such as, again, one more month between the preliminary and post-periods. Indeed, to ensure persistence of the identifier, a certain persistence-ensuring delay (post-period) is waited after the target period. The preliminary, target and post-periods may mutually be of same or different duration. The post-period may be shorter than the target period to minimize the overall analysis delay required since the target period has passed, for example.

Having regard to digital audience analysis of the target period, these identifiers are considered persistent, or at least such property is a requisite for considering the identifier persistent, as depending on the embodiment there may be a number of further conditions to be fulfilled.

Audience estimation is thus calculated with a delay and the algorithm relies on selecting the subset of identifiers which are persistent (i.e. which definitely existed, whether observed or not) during the target time period for which the audience is being reported (the reporting period).

The three periods mentioned above may be but do not have to be mutually of same length. The persistence-ensuring delay (post-period), or ‘persistence delay’, may be, for instance, 14 days, while the target period is still one month.

Generally, depending on the incidence of device-related identifier resets and opt-outs, the persistence delay can potentially be shortened significantly. In the traditional web world, the relatively high incidence of cookie resets and opt-outs makes a 14-day persistence delay a practical requirement. However, there is evidence which suggests that the incidence of e.g. mobile type PDI identifier resets and opt-outs is significantly lower than the analogous incidence of opt-outs and resets for cookies. Accordingly, the persistence delay could be kept short.

The analysis on the gathered incidence data on device-related identifiers and persistent device-related identifiers in connection with transactions may include determination of any one or more elements selected from the group consisting of: persistent transactions during a time period obtained through calculating the total number of transactions associated with persistent device-related identifiers captured during the time period, transactions per persistent device during a time period obtained through dividing the total number of transactions associated with persistent device-related identifiers during the time period by the number of persistent device-related identifiers observed during the time period, total number of transactions delivered by the network during a time period, and net number of devices reached during a time period obtained through dividing the total number of transactions delivered during the time period by the corresponding persistent transactions per persistent device during the time period.

In the above calculations, it may be assumed that the devices which support PUIs but have opted-out of receiving them on average participate in a number of transactions (generate e.g. ad impressions) at the same average frequency as devices which receive PUIs.

Further, the devices which support PUIs but have reset their PUI within a target period will still (on average) participate in a number of transactions (generate e.g. ad impressions) at the same average frequency as devices which have not reset their PUIs.

Yet, the devices which do not support PUIs will still (on average) participate in a number of transactions (generate e.g. ad impressions) at the same average frequency as devices which do support PUIs. Naturally the use of fingerprinting facilitates overcoming the associated accuracy concerns.

These three assumptions are considered justifiable due to the low incidence of opt-out, among other proof.

The data collected enables applying measures such as frequency capping or targeting over the time period during which the device-related identifiers are captured and stored.

As being deliberated hereinearlier, deduplication of audience between a network's different platforms may be achieved by the system 114 utilizing e.g. fingerprinting and/or media measurement data.

If each platform encompassed by the digital network was to collect or calculate or generate a DF e.g. for each device/browser profile that generated a transaction, and the DFs were collected/calculated/generated on different platforms produced using a (functionally, if not technically) identical fingerprinting algorithm, it would be well possible to match device fingerprints between the technical platforms of the overall digital network investigated.

Accordingly, the audience estimation would not be reliant on platform support for PDIs and provide a “fallback position” should PDI support ever change. This is particularly important should e.g. IDFAs or Google Advertising IDs change or be discontinued. Device fingerprinting also provides a natural connection between the audiences reached via different platforms encompassed by the digital network. This connection can be used to both deduplicate audience estimates across platforms and to support frequency capping or targeting integrated across platforms.

An alternative means of deduplicating the two audience estimates is to make use of e.g. a third party's panel-based media measurement data. Using this data, it is possible to calculate the number of users who used one platform encompassed by the digital network, and calculate those users' incidence of usage of elements of a second platform encompassed by the digital network. This would generate a ratio for combined reach which could then be applied to the (more accurate) platform-specific net audience number to produce deduplicated net audience across both delivery platforms.

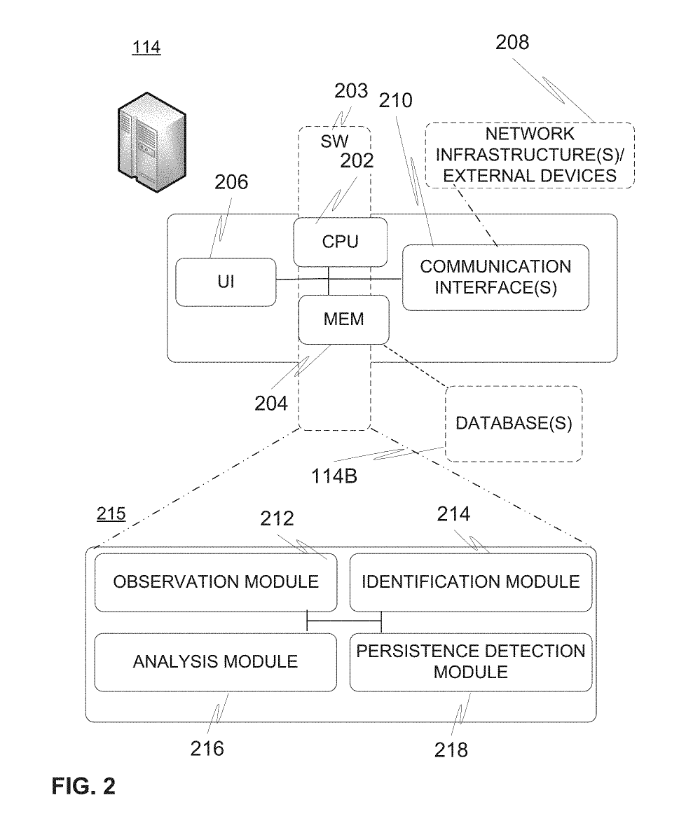

FIG. 2 is a block diagram representing the internals of an embodiment of a system 114 comprising at least one device for implementing the present invention.

The system 114 may be physically established by at least one electronic device, such as a server computer. The system 114 may, however, in some embodiments comprise a plurality of at least functionally connected devices such as servers and optional further elements, e.g. gateways, proxies, data repositories, firewalls, etc. At least some of the included resources such as servers or computing/storage capacity in general may be dynamically allocable from a cloud computing environment, for instance.

At least one processing unit 202 such as a microprocessor, microcontroller and/or a digital signal processor may be included. The processing unit 202 may be configured to execute instructions embodied in a form of computer software 203 stored in memory 204, which may refer to one or more memory chips separate or integral with the processing unit 202 and/or other elements.

The software 203 may define one or more applications for monitoring and analyzing transactions in view of capturing device-related identifiers including the persistent ones. A computer program product comprising the appropriate software code means may be provided. It may be embodied in a non-transitory carrier medium such as a memory card, an optical disc or a USB (Universal Serial Bus) stick, for example. The program could be transferred as a signal or combination of signals wiredly or wirelessly from a transmitting element to a receiving element.

One or more data repositories such as database(s) 114B of preferred structure may be established in the memory 204 for utilization by the processing unit 202.

The repositories may accommodate indications of detected identifiers, related counts, other analysis results, etc.

The UI (user interface) 206 may provide the necessary control and access tools for controlling the system (e.g. definition of identifier capturing rules, monitoring periods, analysis techniques, etc.) and/or accessing the data gathered and calculated (analysis results). The UI 206 may include local components for data input (e.g. keyboard, touchscreen, mouse, voice input) and output (display, audio output) and/or remote input and output optionally via a web interface, preferably web browser interface. The system may thus host or be at least functionally connected to a web server, for instance.

Accordingly, the depicted communication interface(s) 210 refer to one or more data interfaces such as wired network (e.g. Ethernet) and/or wireless network (e.g. wireless LAN (WLAN) or cellular) interfaces for interfacing a number of external devices and systems with the system of the present invention for data input and output purposes. Such external entities may belong to the digital network to be monitored or to reside outside it. The system 114 may be connected to the Internet for globally enabling easy and widespread communication therewith using both stationary and mobile terminal devices or systems and potential network infrastructure(s) in between 208. It is straightforward to contemplate by a skilled person that when an embodiment of the system 114 comprises a plurality of functionally connected devices, any such device may contain a processing unit, memory, and e.g. communication interface of its own (for mutual and/or external communication).

Primarily from a functional standpoint, see the lower block diagram at 215, the system 114 may comprise an observation module 212 for monitoring transactions, which may refer to detecting transactions based on predefined logic. Transactions may be indicated to the module 212 by various elements (e.g. servers or other network elements, and/or clients/user terminals) of the digital network in question, be provided by outside entities, and/or the module 114 may itself monitor data traffic or memory elements storing data relating to transactions in the network and recognize the transactions therefrom.

In some embodiments, the module 212 or system 114 may be situated e.g. as an intermediary in the digital network so that the network traffic including transaction data flows through it, while in some other embodiments the module 212/system 114 may be configured to functionally connect to the elements actually forwarding, creating or storing transaction data.

Further, an identification module 214 may be configured to capture the device-related identifiers. As discussed hereinbefore, the identifiers may include PDIs and DFs, for instance.

Still, a persistence detection module 218 may be configured to determine the identifiers considered persistent from all captured identifiers. The PUIs determined may include persistent PDIs and/or DFs.

Finally, an analysis module 216 is configured to perform analysis on the obtained transaction data. For example, the total digital audience such as net number of devices reached by the network per platform or across platforms thereof may be calculated for desired time periods such as the overall time period and potentially sub-period(s) thereof. Total number of transactions delivered by the network may be determined.

The conducted analysis may naturally involve maintaining identifier counts (number of occurrences of different detected IDs in transactions).

A variety of different statistics may be thus created. The statistics may be output via the UI 206 or communication interface 210 to a number of external devices and systems 208 for utilization.

The potential recipients and users of the created data describing the digital audience may include a control module configured to utilize the data e.g. in the automated design of a digital marketing campaign or adaptation of functionalities or hardware such as network resources, for instance. Such control module may be optionally integrated within the system, e.g. in connection with the analysis module 216.

Having regard to different embodiments of the modules, a person skilled in the art will appreciate the fact that the above modules and associated functionalities may be realized in a number of ways. A module may be divided to functionally even smaller units or two or more modules may be integrated to establish a larger functional entity. In case the system 114 comprises several at least functionally connected devices, the modules may be executed by dedicated one or more devices or the execution may be shared, even with dynamic allocation, among multiple devices (e.g. in a cloud computing environment).

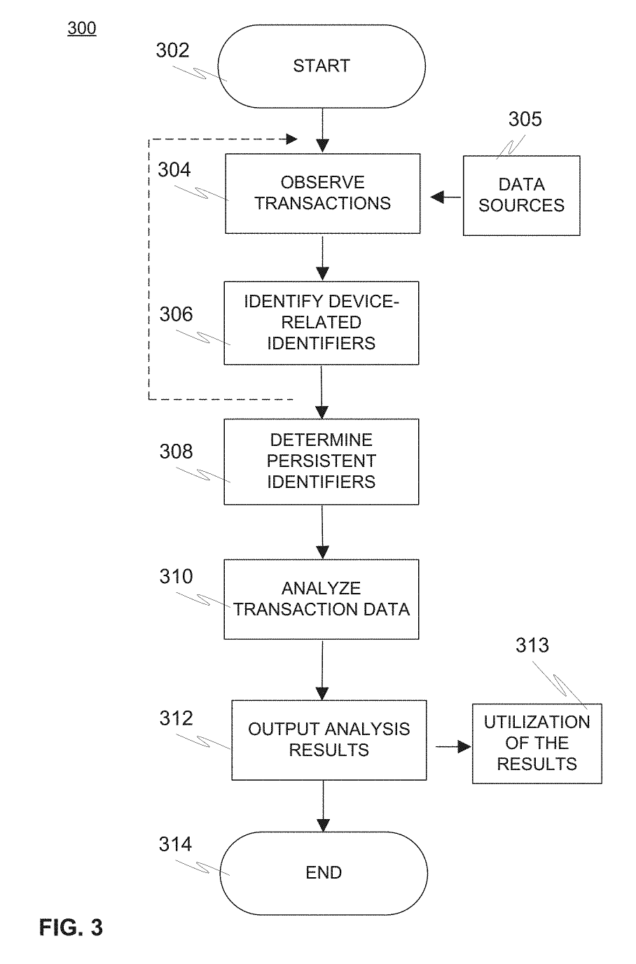

FIG. 3 is a flow diagram of an embodiment of a method in accordance with the present invention.

At 302, referring to a start-up phase, the necessary preparatory actions are executed. The system hardware, such as at least one server apparatus with sufficient data processing, storage and communication capabilities, may be acquired and set up by loading it with appropriate control software. The communication connections relative to external systems may be established and tested. Run-time parameters and e.g. transaction and identifier analysis logic may be determined.

At 304, transactions are monitored on at least one target platform in the digital network for a predefined period, wherein the predefined period comprises at least a preliminary period, a target period, and a post-period.

Transaction data may be obtained from a number of data sources 305 such as servers, gateways, proxies, and/or user terminals/client devices.

At 306, device-related identifiers associated with the observed transactions are captured from the transaction data, wherein a device-related identifier (e.g. PDI or DF) identifies a device or related application profile such as a browser profile, which can be used to identify a related user, i.e. a member of audience.

The identifiers captured may be directly detectable from the transaction data. Alternatively, they may have to be established based on more thorough data analysis, e.g. with a suitable fingerprinting technology.

At 308, it is determined, preferably having regard to each captured device-related identifier, whether it was observed at least one during both the preliminary period and the post-period. If this was the case, the identifier may be considered persistent. In some embodiments, fulfillment of a number of further conditions may be required as well before an identifier can be considered persistent. By default, item 308 is executed after or upon the end of the post-period so that the necessary transaction and related identifier data has become available for the required analysis with certainty.

At 310, desired statistics such as a number of desired digital audience estimates are produced based on the data collected and established, including identifier data and e.g. related counts. The statistics may involve keeping track of identifier counts during the target period, e.g. PUI (PDI and/or DF) counts as described hereinbefore.

A person skilled in the art shall acknowledge the fact that the necessary delay for audience estimates on one platform may be different than for audience estimates on another platform. For instance, as DF longevity may be different (and shorter) than for PDIs, the persistence delay may need to be different as well.

Transaction data may be analyzed over a time period corresponding to e.g. said preliminary, target and post-periods, which may refer to a total period of few months such as three months, in order to determine an appropriate persistence delay (post-period length) taking into account the size of the persistent fingerprint set, and how that size changes throughout the observation period.

Should the persistence delay for different platforms of a digital network be significantly different, the equalization of those delays may be facilitated by implementing a fingerprint evolution attribution as it decreases the need for a persistence delay.

In many cases, one may nevertheless assume that devices whose fingerprints are not persistent throughout the reporting period will still (on average) generate transactions at the same average frequency as devices whose fingerprints are persistent. This assumption may be verified by the analysis of transaction data over the time period.

A desired embodiment of fingerprint evolution attribution may be generally executed when the persistent delays are considerably unequal across the platforms, the detected fingerprint longevity is particularly low according to a predefined criterion, and/or the observed incidence of non-persistent fingerprints is remarkably high according to the used criterion, for example. By fingerprint evolution, it is assumed and acknowledged that the characteristic fingerprints of a predefined entity such as a device may evolve (change) over time. This may be due to a variety of factors, e.g. update of operating system.

Accordingly, fingerprint evolution attribution generally refers to a way of matching a fingerprint determined in one period to a fingerprint collected in an earlier period, i.e. by evolution attribution two slightly different fingerprints arising from the same device at different instants are verified to be associated with the same device.

The evolution attribution logic shall incorporate rules for determining what are the acceptable and likely changes for a device to have undergone in a given time period in terms of related fingerprints.

Further, a predefined frequency capping or targeting method may be executed, optionally substantially in real-time, based on the DFs and/or other device-related identifiers. Capping or targeting may be applied for the delivery of data such as creative ad campaigns.

The percentage of devices for which frequency capping or targeting based on DFs is viable will depend on e.g. fingerprint longevity. As fingerprint longevity decreases, the percentage of devices for which e.g. creative delivery can be frequency capped will decrease as well.

At 312, the analysis results are output via the local UI and/or communications interface of the system for utilization by the recipient(s) 313. Also local exploitation of the results is fully possible.

For example, different sales, marketing and promotional actions may be taken or at least optimized in the analyzed digital network or elsewhere responsive to the results. Such exploitation may be automated such that the receiving entity incorporates e.g. a server or other programmable device that is configured to automatically apply the obtained statistics in the actions such as a digital or mobile marketing campaign. Again, frequency capping of creatives and campaigns having regard to a terminal may be executed based on monitoring the counts of related deliveries to the terminal. Yet, technical optimization such as network computing, storage and/or communications capacity resources may be (re-)allocated based on the results.

At 314, the method execution is ended.

The dotted loop-back arrow reflects the likely repetitive nature of various method items when executed in different real-life and potentially also substantially real-time scenarios wherein transactions occur constantly or every now and then, and the system may perform tasks such as observing transactions and detecting or determining associated device-related identifiers responsive to such transactions without substantial delay.

1. A method (300) for estimating the digital audience (102a, 102b, 102c) reached by a digital network (110) on a digital platform (104a, 104b, 104c) to be performed by computer equipment (114), comprising
monitoring (304) transactions (105a, 105b, 105c, 106) on said platform in the digital network for a predefined period, wherein the predefined period comprises at least a preliminary period, target period, and post-period, which are temporally sequential,
capturing (306) device-related identifiers associated with the observed transactions, wherein the device-related identifier preferably anonymously identifies a device or device user or related application profile, optionally a browser profile,
determining (308), for each captured device-related identifier, whether it was observed at least once during both said preliminary period and said post-period, to extract persistent device-related identifiers from the captured device-related identifiers, and
calculating statistics (310, 312, 313) preferably containing aggregate statistics having regard to the persistent device-related identifiers and related transactions, during the target period.

2. The method of claim 1, wherein the target period and post-period are of different duration, the post-period being preferably shorter than the target period.

3. The method of any preceding claim, wherein the calculation of statistics include at least one element selected from the group consisting of: persistent transactions during a time period obtained through calculating the total number of transactions associated with persistent device-related identifiers captured during the time period, transactions per persistent device during a time period obtained through dividing the total number of transactions associated with persistent device-related identifiers during the time period by the number of persistent device-related identifiers observed during the time period, total number of transactions delivered by the network during a time period, and net number of devices reached during a time period obtained through dividing the total number of transactions delivered during the time period by the corresponding persistent transactions per persistent device during the time period.

4. The method of any preceding claim, wherein the occurrence counts of captured device-related identifiers are kept track of.

5. The method of any preceding claim, wherein the device-related identifiers include at least one element selected from the group consisting of: anonymous unique identifier, cookie, registration data, anonymous unique device identifier, anonymous unique user identifier, Google Advertising ID™, Apple IDFA™ (Apple Identifier for Advertising), and platform-dependent identifier.

6. The method of any preceding claim, wherein the device-related identifiers include fingerprints indicative of a plurality of device-related characteristics.

7. The method of claim 6, wherein a fingerprint includes an indication of at least one element selected from the group consisting of: user agent, web browser, browser micro-version, OS (Operating System) version, language, toolbars and/or other device identification data), HTTP (Hypertext Transfer Protocol) ACCEPT header, cookie status, screen resolution, time zone, browser plug-ins, plug-in version, plug-in MIME (Multipurpose Internet Mail Extensions) type, system fonts, geolocation, IP (Internet Protocol) address, super cookie test and partial super cookie test.

8. The method of any preceding claim, configured to monitor transactions and capture device-related identifiers on a plurality of digital platforms of the digital network.

9. The method of any preceding claim, wherein the digital audience is estimated on at least one platform selected from the group consisting of: desktop web, mobile web, and mobile apps.

10. The method of any preceding claim, configured to match fingerprints collected on multiple digital platforms of the digital network to deduplicate the digital audience across the network.

11. The method of any preceding claim, comprising executing frequency capping of content, preferably digitally deliverable creative or campaign, having regard to a terminal device based on the captured device-related identifiers.

12. The method of any preceding claim, configured to deduplicate the digital audience utilizing multiple platforms of the digital network based on obtained panel-based media measurement data indicative of users' network usage on said multiple platforms.

13. A system (114, 114B, 215) for estimating the digital audience (102a, 102b, 102c) reached by a digital network (110) on at least one digital platform (104a, 104b, 104c), comprising
observation module (202, 203, 204, 210, 212) configured to monitor transactions on said platform in the digital network for a predefined period, wherein the predefined period comprises at least a preliminary period, target period, and post-period, which are temporally sequential,
identification module (202, 203, 204, 214) configured to capture device-related identifiers associated with the observed transactions, wherein the device-related identifier preferably anonymously identifies a device or device user or related application profile such as browser profile,
persistence detection module (202, 203, 204, 218) configured to determine, for each captured device-related identifier, whether it was observed at least once during both said preliminary period and said post-period, to extract device-related identifiers that are considered temporally persistent from the captured device-related identifiers, and
analysis module (202, 203, 204, 216) configured to calculate statistics preferably containing aggregate statistics having regard to the persistent device-related identifiers and related transactions, during the target period.

14. A computer program, comprising computer code configured, when executed on a computer, to
monitor transactions on said platform in the digital network for a predefined period, wherein the predefined period comprises at least a preliminary period, target period, and post-period, which are temporally sequential,
capture device-related identifiers associated with the observed transactions, wherein the device-related identifier preferably anonymously identifies a device or device user or related application profile, optionally a browser profile,
determine, for each captured device-related identifier, whether it was observed at least once during both said preliminary period and said post-period, to extract persistent device-related identifiers from the captured device-related identifiers, and
calculate statistics preferably containing aggregate statistics having regard to the persistent device-related identifiers and related transactions, during the target period.
